(19) United States
(12) Patent Application Publication
(10) Pub. No.: US 2009/0020727 A1
(43) Pub. Date: Jan. 22, 2009

(54) Magnetic receptive plasters and compounds

(76) Inventor: Dayton Joseph Deetz, Mendon, MA (US)

Correspondence Address: Dayton J. Deetz, 43 Taft Avenue, Mendon, MA, 01756, US

(21) Appl. No.: 11/116,819

(22) Filed: Apr. 28, 2005

(51) Int. Cl. H01F 1/00

(52) U.S. Cl. 252/62.51 R; 252/62.55; 252/62.56; 106/643; 106/733; 106/772

(57) ABSTRACT

Magnetic receptive Paints and coatings have been developed to allow one to paint a wall with this coating and apply magnets to this surface. The further development of magnetic receptive compounds lends itself to creating a one step process where one applies a magnetic receptive plaster or compound to a wall with a viscosity sufficient to smooth with a trowel leaving a magnetic receptive surface. In other applications one could spray a compound on a given surface.

### TECHNICAL FIELD OF THE INVENTION

This invention employs the use of ferromagnetic particles dispersed in compounds such as spackling compound, plaster, joint compounds and the like. The use of magnetic receptive plasters will give options for magnetic wall systems other than paints. In the past magnetic paints have been used to create a magnetic receptive area in a room to use for message boards, to hang artwork or in a graphics application for commercial use. The applications are very wide and growing. The availability of a magnetic Plaster type product would give the option for a plasterer to use a magnetic plaster and without any extra steps create a magnetic receptive surface.

### SUMMARY OF THE INVENTION

Magnetic plaster is produced simply by blending ferromagnetic particles with a dry or wet medium. This can be accomplished with iron magnetite or any other ferromagnetic material. Whether this is packaged as a pre-mix (dry) powder or sold as a two-part system, the results will be the same. It is important when using an iron product to use an anti-flash rusting agent such as sodium benzoate or sodium nitrite. This will prevent the iron from reacting given the large quantities of water needed to blend the plaster. This is not necessary when employing magnetite.

### DETAILED DESCRIPTION OF THE INVENTION

When formulating Magnetic compounds it is important to bring the load of magnetic particles up to a level that will perform well holding magnets but not dilute the strength of the medium. One product will work as an additive in a two-part system. This will give the operator the ability to add the needed amount of magnetic particles for the given job. We will blend iron powder with sodium benzoate, at a ratio of 1%-5% of the weight of iron for example if we use 100 lbs of iron I will add between 1 and 5 lbs of sodium benzoate. This can then be blended with dry plaster in quantities from about 20-80 percent. After this is blended it can be packaged and sold. Just add water and blend as normal plaster. When employing Magnetite the need for an anti-oxidizer is not necessary. The formulation would be the same as pre-disclosed excluding the sodium benzoate.

### EXAMPLES

The following examples are presented to further illustrate and explain the present invention and should not be taken as limiting in any regard.

### Example 1

In one embodiment we blend 50 lbs of plaster with 125 lbs of iron and 4.3 lbs of sodium benzoate. Add sufficient amounts of water and blend until smooth. This is now ready to trowel on a wall and create a magnetic receptive wall.

### Example 2

Here we have blended a dry mix of iron and sodium benzoate into a bucket of joint compound used in a sheetrock application. We have added 60 lbs of iron and 1.8 lbs of sodium benzoate to the pre-mixed medium. Blend well and trowel on the wall.

These compounds can be pre-mixed either dry or wet to make available a magnetic receptive option for applied compound finishing systems.

1. A magnetic receptive compound employing ferromagnetic particles (not a paint) to be applied to a surface.

2. A plaster blended with ferromagnetic particles

3. A joint compound blended with ferromagnetic particles.

4. A magnetic receptive compound according to claim 1 with the addition of an anti oxidizing agent

5. A magnetic receptive plaster according to claim 2 with the addition of an anti oxidizing agent

6. A magnetic receptive joint compound according to claim 3 with the addition of an anti-oxidizing agent

7. A dry compound or coating additive employing Iron powder and an anti-oxidizing agent.

8. A magnetic receptive dry additive for use in adding to compounds or coatings in a dry form employing magnetite.

9. A dry compound or coating additive employing Iron powder.
